(19) United States
(12) Patent Application Publication
(10) Pub. No.: US 2026/0105104 A1
(43) Pub. Date: Apr. 16, 2026

(54) Learning to Rank with Asymmetric Matching Losses

(71) Applicant: Google LLC, Mountain View, CA (US)

(72) Inventors: Gil Shamir, Sewickley, PA (US); Manfred Klaus Warmuth, Santa Cruz, CA (US)

(21) Appl. No.: 18/913,665

(22) Filed: Oct. 11, 2024

(51) Int. Cl. G06F 16/9038

(52) U.S. Cl. CPC G06F 16/9038

(57) ABSTRACT

Provided are asymmetric matching losses with link functions that enhance high grade labels, such as exponential functions, for ranking problems that attempt to optimize Normalized Discounted Cumulative Gain (NDCG) in retrieval applications with graded relevance item labels. A matching loss is defined as the integral between a true label and a predicted score over a link function. Asymmetric matching losses can be obtained by using monotonically increasing or monotonically non-decreasing link functions that increase at different rates over the label domain. Exponential growth link functions, which are aligned with the definition of the NDCG metric. With their asymmetry and steepness at high grades, they give preference to items with high relevance labels, discounting items with low relevance labels. They thus lead to accurate ranking of items with high grades, at the expense of ranking the low grades, yet ensuring that items with low grades are never ranked high.

### FIELD

The present disclosure relates generally to machine learning technologies. More particularly, the present disclosure relates to learning to rank with asymmetric matching losses.

### BACKGROUND

In the field of information retrieval, a technical challenge lies in efficiently and accurately ranking retrieved items according to their relevance to a given query. Traditional learning-to-rank methods, such as those utilizing cross-entropy or LambdaRank, often struggle with computational complexity and the inability to directly optimize for ranking metrics like Normalized Discounted Cumulative Gain (NDCG). These methods typically require extensive computational resources, especially in scenarios involving large datasets, due to their reliance on pairwise or listwise loss calculations which scale quadratically with the size of the item list.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method to train a machine-learned ranking model. The computer-implemented method includes obtaining, by a computing system which may include one or more computing devices, a training example which may include: (i) data descriptive of an item and (ii) a label value respectively associated with the item. The method also includes processing, by the computing system, the data descriptive of the item with the machine-learned ranking model to generate a predicted item score for the item as an output of the machine-learned ranking model. The method also includes evaluating, by the computing system, an asymmetric matching loss function that evaluates an area under a monotonically-increasing or monotonically non-decreasing link function from the label value to the predicted item score. The method also includes modifying, by the computing system, one or more values of one or more parameters of the machine-learned ranking model based on the asymmetric matching loss function. Other embodiments of this aspect include corresponding computer systems, apparatus, and computer programs recorded on one or more computer storage devices, each configured to perform the actions of the methods.

Example implementations may include one or more of the following features. The computer-implemented method where the link function may include a standard exponential function or an exponential function that has been one or both of scaled and shifted. The link function may include a standard sigmoid function or a sigmoid function that has been one or both of scaled and shifted. The link function may include one or more flat regions where adjacent labels are not penalized by the loss function. The link function may include a capped upper region. The loss function may include two or more different link functions applied for different label values or different regions of predicted item scores. The link function may be adjusted, scaled, or discounted using one or more quantities derived from a normalized discounted cumulative gain metric, and where the link is normalized by a maximum value of the normalized discounted cumulative gain metric or a discount applied to the normalized discounted cumulative gain metric. The asymmetric matching loss function may be analytically inexpressible but a gradient of the asymmetric matching loss function may include a difference in evaluations of the link function at the predicted item score and the label value, and where evaluating, by the computing system, the asymmetric matching loss function may include of determining, by the computing system, the gradient of the asymmetric matching loss function. The training example further may include data descriptive of a query; the item may be a single item; processing, by the computing system, the data descriptive of the item with the machine-learned ranking model to generate the predicted item score may include processing, by the computing system, the data descriptive of the item and the data descriptive of the query with the machine-learned ranking model to generate a pointwise predicted item score; and the pointwise predicted item score indicates a pointwise level of relevance for the single item relative to the query. Implementations of the described techniques may include hardware, a method or process, or computer software on a computer-accessible medium.

One general aspect includes a computing system configured to train a machine-learned ranking model. The computing system may be configured to perform operations. The operations include obtaining, by the computing system, a training example may include: (i) data descriptive of a first item and a second item and (ii) one or more label values respectively associated with the first item and the second item. The operations include processing, by the computing system, the data descriptive of the first item with a machine-learned ranking model to generate a first predicted item score for the first item as an output of the machine-learned ranking model. The operations include processing, by the computing system, the data descriptive of the second item with the machine-learned ranking model to generate a second predicted item score for the second item as an output of the machine-learned ranking model. The operations include generating, by the computing system, a pairwise scoring representation for the first item and the second item based on the first predicted item score and the second predicted item score. The operations include evaluating, by the computing system, an asymmetric matching loss function that evaluates an area under a monotonically-increasing or monotonically non-decreasing link function from a pairwise label representation to the pairwise scoring representation, the pairwise label representation may include or being derived from the one or more label values respectively associated with the first item and the second item. The system also includes modifying, by the computing system, one or more values of one or more parameters of the machine-learned ranking model based on the asymmetric matching loss function. Other embodiments of this aspect include corresponding computer systems, apparatus, and computer programs recorded on one or more computer storage devices, each configured to perform the actions of the methods.

Implementations may include one or more of the following features. The computing system where the pairwise scoring representation may include a difference between the first predicted item score and the second predicted item score. The one or more label values may include a first label value associated with the first item and a second label value associated with the second item, and where the pairwise label representation may include a difference between the first label value and the second label value. The one or more label values and the pairwise label representation both may include a preference label between the first item and the second item. The link function may include a hyperbolic sine function or a hyperbolic sine function that has been one or both of scaled and shifted. The link function may include a standard sigmoid function or a sigmoid function that has been one or both of scaled and shifted. The link function may include an odd function asymmetric about an origin. Implementations of the described techniques may include hardware, a method or process, or computer software on a computer-accessible medium.

One general aspect includes one or more non-transitory computer-readable media that collectively store computer-executable instructions for performing operations for listwise training. The operations include obtaining, by a computing system, a training example may include: (i) data descriptive of a plurality of items and (ii) a plurality of label values respectively associated with the plurality of items. The operations include processing, by the computing system, the data descriptive of the plurality of items with a machine-learned ranking model to generate a plurality of predicted item scores respectively for the plurality of items as an output of the machine-learned ranking model. The operations include generating, by the computing system, a model-based discounted cumulative gain from the plurality of predicted item scores. The operations include generating, by the computing system, a ground truth maximum discounted cumulative gain from the plurality of label values. The operations include evaluating, by the computing system, a matching loss function that matches the model-based discounted cumulative gain to the ground truth maximum discounted cumulative gain. The operations include modifying, by the computing system, one or more values of one or more parameters of the machine-learned ranking model based on the matching loss function. Other embodiments of this aspect include corresponding computer systems, apparatus, and computer programs recorded on one or more computer storage devices, each configured to perform the actions of the methods.

Implementations may include one or more of the following features. The one or more non-transitory computer-readable media where a multiclass link function is defined with a generalization of a softmax function in which a label generated score of each item is discounted by a discount which is a function of a position of the item in an ordering that maximizes an overall discounted cumulative gain score. A link function for each item may be linear, exponential, or other increasing function. In addition to matching a generalized softmax score for each item of the plurality of items, an additional loss may be applied to match a cumulative softmax score of labels of all items with an asymmetric matching loss. The matching loss function may match the plurality of predicted item scores to a gain-discount quotient determined using an applied gain and maximum gain based item ordering discount. Implementations of the described techniques may include hardware, a method or process, or computer software on a computer-accessible medium.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates an example matching loss as an area under an example link function according to example embodiments of the present disclosure.

FIG. 2 illustrates example loss regions for example matching losses according to example embodiments of the present disclosure.

FIG. 3 illustrates example shifted and scaled curves of example link functions according to example embodiments of the present disclosure.

FIG. 4 illustrates examples of predicted expected label with an example exponential link matching loss according to example embodiments of the present disclosure.

FIG. 5 illustrates a block diagram of an example pointwise training approach according to example embodiments of the present disclosure.

FIG. 6 illustrates a block diagram of an example pairwise training approach according to example embodiments of the present disclosure.

FIG. 7 illustrates a block diagram of an example pairwise training approach according to example embodiments of the present disclosure.

FIG. 8A depicts a block diagram of an example computing system according to example embodiments of the present disclosure.

FIG. 8B depicts a block diagram of an example computing device according to example embodiments of the present disclosure.

FIG. 8C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods that perform learning to rank with asymmetric matching losses. These asymmetric matching losses can be designed to prioritize the accurate ranking of items of greater importance, thereby aligning the focus of the loss with the key objectives of the ranking task. In particular, some example implementations use asymmetric matching losses with link functions that enhance high grade labels, such as exponential functions, for ranking problems that attempt to optimize Normalized Discounted Cumulative Gain (NDCG) in retrieval applications with graded relevance item labels.

A matching loss can be defined as the integral between a true label and a predicted score over a link function. Asymmetric matching losses can be obtained by using monotonically-increasing (or monotonically non-decreasing) link functions that increase at different rates over the label domain. As an example, exponential growth link functions are generally aligned with the definition of the NDCG metric. With their asymmetry and steepness at high grades, they give preference to items with high relevance labels, discounting items with low relevance labels. They thus lead to accurate ranking of items with high grades, at the expense of ranking the low grades, yet ensuring that items with low grades are never ranked high. Other asymmetric functions exhibit different tradeoffs while still focusing on high magnitude grades or differences and discounting low magnitude grades or differences. These properties make asymmetric losses a perfect match for optimizing NDCG ranking metrics.

The proposed matching losses give low-complexity solutions to the retrieval metric optimization problem with linear complexity in the size of the retrieved item list, unlike existing approaches like LambdaRank, which require quadratic complexity in the size of the list. Further, while the proposed framework can be used with pointwise losses for optimizing listwise metrics (e.g., NDCG), the present disclosure also demonstrates that pairwise losses based on the magnitude of grade differences can also be applied with asymmetric losses, again focusing on high magnitude grade differences and discounting low magnitude differences.

The proposed techniques provide a number of technical effects and benefits. As one example, the use of asymmetric matching losses for learning-to-rank tasks significantly reduces the consumption of computational resources such as processor cycles and memory. This efficiency is achieved because the asymmetric losses emphasize accurate ranking for items with high relevance labels while discounting items with lower relevance. This targeted focus allows the training process to allocate computational efforts more effectively, optimizing for high-grade labels that contribute most significantly to the Normalized Discounted Cumulative Gain (NDCG) metric.

Additionally, some example implementations of the proposed approach simplify the complexity of the optimization problem from quadratic, as seen in methods like LambdaRank, to linear in relation to the size of the retrieved item list. This linear complexity means that computational resources are used more efficiently, as example implementations of the proposed systems do not need to process every potential pairwise comparison within a list, but rather focus on optimizing individual scores directly against their true labels.

As another example technical benefit, example implementations of the proposed approach are inherently label-value-aware, which means that even in scenarios where pairwise training data is sparse or incomplete, the system can still effectively align with the gains emphasized by the NDCG metric. Furthermore, the ability to train on unranked items and accommodate lists of variable sizes offers significant versatility. This allows the model to be applied in diverse settings without the strict requirement of pre-ranked training data. Finally, the approach is robust against shifts in list labels. This robustness ensures that the model remains effective and reliable in scenarios where there may be variations or shifts in label distributions across different lists.

### INTRODUCTION

### Information Retrieval

In information retrieval, a set of documents or items are retrieved or shown to a user in response to a request or a query. A query can include any request for information or data, an may be posed in various forms, such as a question, statement, or set of keywords. A query can be user-generated or user-submitted or can be automatically generated or submitted (e.g., by an autonomous agent or software system). Queries can be expressed in natural language, structured query languages, and/or through other input methods such as voice commands or graphical interfaces. One example query is a web query. An item can include any individual unit of content or data that can be retrieved, displayed, or manipulated. This could include documents, web pages, images, videos, entities, database records, or any other form of digital or analog content.

In response to a query, a model can rank candidate items that are potentially responsive to the query. The information retrieval system can select the top candidates to retrieve or show the user, based on some relevance scores it predicts for the candidates relative to the query or request. In the training process, a model learns to predict relevance scores for future inference on yet unseen query examples. When deployed, a model predicts scores for a candidate set for a given request, and ranks the candidates according to these scores. Based on the predictions, a list of candidates is retrieved and/or shown to the user in the order of the relevance scores the model predicted. The goal is to maximize matching between the ranking order assigned by the model scores and the ranking that is obtained by the ground truth relevance scores after they are revealed. In general, the actual scores are less important than achieving the correct ordering.

The quality of the ranking performance of a model can be measured on test data by metrics that are maximized if the documents are correctly ordered according to the true relevance labels. Cumulative Gain (CG) (of order n), sometimes referred to as graded precision, sums some function of the relevance scores of the items in the first p positions. The contribution of an item to the cumulative gain can be linear with respect to the relevance score. However, in many applications, an item with a higher relevance score is substantially more important than one with a lower score. This leads to the use of nonlinear increasing functions (such as exponential ones) to measure the gain of an item based on its relevance score.

In many retrieval systems (e.g., recommendation systems), items placed in earlier positions are more likely to be engaged with. This gives rise to metrics like Discounted Cumulative Gain (DCG), that discount the relevance score by a discount inversely proportional to the position. If the item is at a top position, the discount is minimal, and it increases with the position (that is, “later” positions are discounted more heavily). This discounts the effect of items placed in worse positions on the evaluation metrics, even when they receive high grades.

In many applications, measuring the performance of retrieval should weight all queries equally. DCG metrics depend on ground truth labels, and may not be equal for different lists of items (included in a response to a retrieval query). This is exacerbated with exponential gain scores. To equalize the contribution of each list, a Normalized Discounted Cumulative Gain (NDCG) score is used, by normalizing the computed DCG score by the DCG score that is computed for the best possible ranking, in which items are ordered in a descending order of the ground truth relevance scores (assuming a high score is the best).

### Ranking Losses

The learning-to-rank research line of work focused on developing methods to improve ranking for retrieval problems. Classical methods, such as cross-entropy, optimize a pointwise label loss in training to obtain accurate label predictions, which can also lead to good ranking.

However, such methods do not model the pairwise and/or listwise relations between different items in a retrieved list. Learning to rank methods applying pairwise and listwise losses establish connections between the relevance scores learned for multiple items shown in the same list. Such connections allow scores to adjust to relations between the items, possibly eliminating the effects of signals that do not influence ranking (such as query-only signals). Using such losses in underspecified models (where some “real” features are not accounted for, or are marginalized by engineered features), can leverage underspecification and misspecification of the model to improve ranking behavior, but possibly at the expense of prediction accuracy on the individual labels.

Pairwise and listwise ranking losses may improve ranking among items. They tend to improve the probability that if item A is ranked over item B then its true label is more likely to be better than that of item B. Metrics like Area Under the Curve (AUC) may reflect this behavior for, e.g., the pairwise loss. However, such ranking improvements may not be aligned with retrieval metrics such as NDCG. NDCG cares about ordering the whole list, not just pairs. However, it cares more about the top grades, and much less about low grades.

Ample work has focused on deriving losses and optimization methods to improve NDCG scores. However, because the NDCG score relies on sorting the items by their relevance labels, it is not differentiable, leading to difficulty in deriving a differentiable loss function that directly approximates the NDCG scores. The Lambda Loss approach, which is described in Burges, From RankNet to LambdaRank to LambdaMART: An Overview, Microsoft Research Technical Report MSR-TR-2010-82, weighs a pairwise loss by the gain obtained if the pair of items is correctly ranked. The gain is obtained from both the label gain and the ranking position discount. This approach does not directly minimize the NDCG metric, but it penalizes incorrect ranking according to weights that are aligned with NDCG. Alternative methods use a stochastic Gumbel distribution approximation to approximate the NDCG loss attempting to address cases in which the training list is properly sorted, yet other ranking losses do not apply a loss because of the correct order in the list.

### Asymmetric Matching Losses and Motivation

Classical training losses, such as cross-entropy logistic regression, do not provide much flexibility to match different label values. Cross-entropy is, in fact, designed for soft classification to distinguish well between extreme classes. Linear regression square losses are sensitive to outliers, and do not give preference to one region over another in the learned score (activation) domain.

According to an aspect of the present disclosure, matching losses provide such flexibility. Consider a monotonically increasing (or monotonically non-decreasing) link function h(z). The function can be, for example, linear, the standard logistic (Sigmoid) function, a scaled and/or shifted Sigmoid, or a (standard or scaled and/or shifted) exponential function. If we try to match a score â to some ground truth label a, we can define the integral from a to â on h(z)−h(a) as the loss. Such a loss is minimized (for a monotonically increasing or non-decreasing h(x)) at â=a. It has a gradient which equals h(â)−h(a) at z=â, which is uniquely defined by the link function. Interestingly, this loss is a Bregman Divergence between points â and a for the primitive antiderivative H(z) of the link function h(z).

In regions of a where the function is fast increasing, erring on the score â leads to high loss and large gradients. In regions of slow increase, on the other hand, the loss is small if â is predicted instead of a. Using an exponential function as the link function thus highly penalizes being away from the true label for larger true labels, yet, assigning small penalties to true labels that are smaller, as long as the predicted scores are also small. If the predicted score â is large for a small label a, the loss, again, becomes large, as the interval between the values contains a region with fast increase of the link function.

These properties of asymmetric matching losses; distinguishing well among examples in the high label region, and keeping examples with low labels away from the high label region but discarding differences between them in the low label region, are exactly the properties one needs to optimize for metrics such as NDCG. Large labels must be more accurately predicted, and if the prediction is away, the loss should be large. Items with smaller labels usually get pushed to the discounted region, so accuracy on those is not critical, unless the predictions assign large labels to such items. In the latter case, the losses increase, and enable quick correction with gradient methods. The asymmetric behavior of the loss which favors the fast increase region allows for better regret of a learning algorithm in this region (with faster convergence to the optimum). The asymmetric behavior also assists in resolving mis- and under-specification in favor of better predicting the labels in the competitive region in which the link function changes fast.

Some link functions, such as the Sigmoid function, cap the large loss for larger label values at some point. However, an exponential (or similar) link function does not. The exponential function fits the exponential NDCG metrics, and some implementations can use the same exponential function as is used with the NDCG metric. However, if it is desired to guarantee that the model does not generate predictions that exceed some label value (e.g., even if training data contains larger labels), capping the growth of the link function (e.g., by using a Sigmoid) may, in fact, be useful. Note that with the linear version on NDCG, matching losses can also be used, though essentially giving gradients that equal to those of linear regression with a square loss.

The present disclosure proposes using asymmetric matching losses for learning-to-rank, for example when optimizing for NDCG. Such losses fit the NDCG metric by emphasizing on the larger labels, where NDCG emphasizes on these labels, giving a ranking which is better at the higher relevance region. The proposed losses also discount lower relevance labels if the predicted labels are of low relevance; and yet they penalize high relevance predictions for low relevance labels, similarly to the NDCG metric.

Unlike Lambda Loss, or certain pairwise approaches, example implementations of the present disclosure can optimize with an asymmetric matching loss with linear complexity as a pointwise loss. In contrast, Lambda Loss, for example, requires square complexity per list by updating all ordered label pairs in the list. (Listwise losses are also with linear complexity, but may not be as good as the pairwise ones, and also may require multiple applications of the loss to the list if there are multiple positives and/or multiple grades of positive, for example as seen with softmax or unique softmax listwise losses). Further, while some example implementations of the present disclosure optimize for NDCG scores with a pointwise asymmetric matching loss, the present disclosure also provides pairwise variations that can be used with relevance grade difference labels.

Additional advantages of asymmetric matching losses include the ability to provide closed form optimization, where the loss can be explicitly differentiated and optimized, unlike Lambda Loss for which the gains and discounts must be computed first for each pair. This allows applying the loss at once on a whole training batch by accumulating all metrics instead of an iterative application with techniques as the Lambda Loss, that require the predicted permutation of each list to first compute the discounts for all items.

Furthermore, matching losses can be uniquely defined through their gradients, as functions of the link function. As such, the framework also provides the ability to define losses for which there may be no analytical expression of the actual loss, as long as its gradient can be defined.

Unlike discount-based losses, such as the Lambda Loss, when using asymmetric losses the loss can be applied as long as the predicted label does not match the true one. With Lambda loss when ordering is correct, no loss is applied even when the labels do not match. Enhancing matching of the prediction to the true label can be beneficial across different lists with different orderings, especially when the high grade labels are well matched, allowing for possible better optimization of metrics like NDCG, which heavily rely on proper ranking of the high grade labels.

### Example NDCG and Lambda Losses

### Normalized Discounted Cumulative Gain (NDCG)

Example implementations operate within a learning setup where in each query, a list of N items is being retrieved. (Specifically, N_{q} items are being retrieved for the q-th query in a training set of Q queries, but the remainder of this description omits the subscript q for brevity.) The items are assigned (ground truth) relevance labels yᵢ∈{0, 1, 2, 3, . . . , L}, which at inference-time are not known to a prediction model. Typically, relevance scores are increasing, i.e., 0 is the worst relevance, and L is the best one. The prediction model produces prediction scores sᵢ for each of the items. Using these scores the items are ranked, such that the item with the best (largest) score is ranked in the first position. Some example implementations may only care about the first n, n≤N ranked items. Without loss of generality, assume that the order of the items is the one assigned by the model, where the item with the largest model relevance score is item i=1, and so on.

There are multiple possible CG metrics. In a linear one, the gain of an item is its score. A standard exponential CG metric, gives the item in position i with label yᵢ gain of 2^{y}^{ᵢ}−1. To compute the DCG metric, a discount is defined as a function of the position the model assigns to an item. Again, various discount functions can be defined, including the reciprocal of i, and the reciprocal of the logarithm of i+1 (the 1 is added to avoid division by 0). It became standard to use logarithm to the base of 2, and use 1/log₂(i+1) as the discount function. Note that the discount function in DCG is the only dependence of the metric on the predictions of the model. It is not a direct function of the model scores, but of the ranking that results from its scores. A linear per-query nth order DCG metric is thus given by

$${DCG}_{n} = {\sum }_{i = 1}^{n} \frac{{y}_{i}}{{log}_{2} ( i + 1 )} \qquad ( 1 )$$

Similarly, an exponential nth order DCG metric is given by

$${DCG}_{n} = {\sum }_{i = 1}^{n} \frac{{2}^{{y}_{i}} - 1}{{log}_{2} ( i + 1 )} \qquad ( 2 )$$

Both scores give 0 gain to a label yᵢ=0, and discount of 1 to the item in position 1.

With the best possible ranking for the best n labels, the DCG metric is different between one query and another. To make the best possible ranking consistent across the different queries, the Normalized DCG (NDCG) metric is defined. Let maxDCGₙ be the n-th order DCG score for the best possible ranking for the query. Then, the NDCG (exponential) score for the query is defined as

$${NDCG}_{n} = \frac{1}{{maxDCG}_{n}} \cdot {{\sum }^{n}}_{i = 1} \frac{{2}^{{y}_{i}} - 1}{{log}_{2} ( i + 1 )} {=}^{△} {\sum }_{i = 1}^{n} \frac{{G}_{i}}{{D}_{i}} \qquad ( 3 )$$

where we defined each item's gain and discount as

$${G}_{i} {=}^{△} \frac{{2}^{{y}_{i}} - 1}{{maxDCG}_{n}} , {D}_{i} {=}^{△} {log}_{2} ( i + 1 ) \qquad ( 4 )$$

NDCG can be defined similarly for the linear gain version.

### LambdaRank Loss

A pairwise ranking loss (for binary labels) computes the logistic (Sigmoid) function on the score difference of the scores predicted for the pair of items. This function can be interpreted as the conditional probability of one item having a better label than the other conditioned on the event that they have unequal labels. A loss minimizes the negative logarithm of this probability. The LambdaRank loss computes the same loss, but weighs it as a function of both the gain difference between the items and the discount difference. The loss is given by

$$L ( y , s ) = {\sum }_{{y}_{i} > {y}_{j}} \vert {G}_{i} - {G}_{j} \vert \cdot \vert \frac{1}{{D}_{i}} - \frac{1}{{D}_{j}} \vert \cdot log ( 1 + {e}^{- ( {s}_{i} - {s}_{j} )} ) \qquad ( 5 )$$

where y and s denote the label and score vectors including the first n items in the list, respectively. The logarithm can be taken with respect to any base (just scaling the loss), and the exponent can have a temperature variable a that can be tuned. The loss enhances pairwise components of the loss that include high relevance items in the pair, as well as items that are placed in better positions by the model (even if their true relevance label would have placed them lower on the list). This is consistent with the desired behavior to optimize the NDCG score. However, the expression does not directly maximize the NDCG score in equation (3). It also requires quadratic complexity for computing pairwise losses in each list. Furthermore, the produced scores may not be directly related to the relevance labels. In applications in which the predicted relevance scores themselves are also important, and not only their ranking, this may be a disadvantage.

### Example Matching Losses

### Example Binary Case

Let h(z) be a link function, which we use to define a matching loss. The matching loss attempts to match an estimate â of the true activation a to the true activation a. The activation a can be a logit score, a probability, or any other statistics we are trying to match. The matching loss can be defined directly from its gradient with respect to the desired estimator

$${g}_{m} ( \hat{a} , a ) {=}^{△} \frac{\partial {L}_{match} ( \hat{a} , a )}{\partial \hat{a}} {=}^{△} h ( \hat{a} ) - h ( a ) \qquad ( 6 )$$

The gradient of the loss is simply the difference in values of the link function at the estimate and at the true value of the statistics, which can be a true label, which is observed and to which the model attempts to match a prediction.

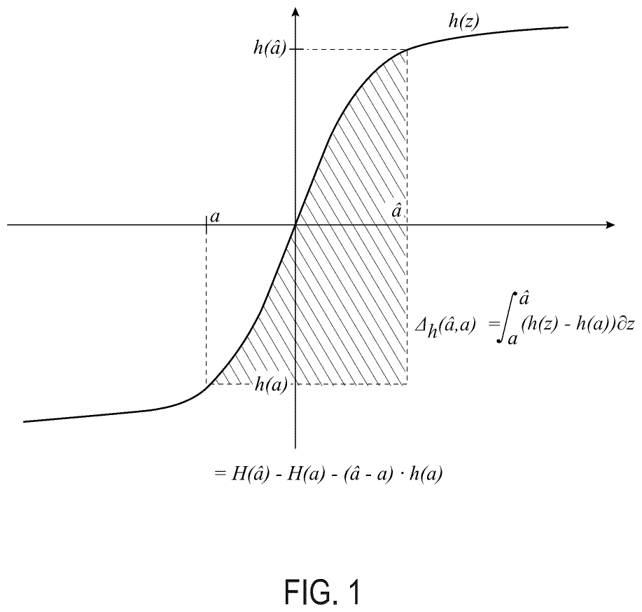

The actual loss is the integral on the link difference

$${L}_{match} ( \hat{a} , a ) = {\int }_{a}^{\hat{a}} [ h ( z ) - h ( a ) ] dz = H ( \hat{a} ) - H ( a ) - ( \hat{a} - a ) \cdot h ( a ) \qquad ( 7 )$$

where H(z) is the primitive antiderivative of the link h(z). Interestingly, the loss in (7) is the Bregman divergence, which is the difference between the function H(⋅) at â and its first-order Taylor expansion around a. For a monotonic non-decreasing h(z), the loss gives the additional increase in area covered by the function from a to â. This is illustrated in FIG. 1, which illustrates an example matching loss as an area under an example link function.

The simple form of the gradient of the matching loss gives an easy recipe to define losses according to different sensitivity requirements. Specifically, in regions in which the link is steep, a larger loss with a larger gradient is applied. In flat regions the loss is smaller. The simple definition of the loss in Equation (6) also gives a handle to directly determine the loss gradient, and even design losses for which the actual loss cannot be analytically expressed, but with a gradient that still satisfies desired sensitivity properties. Additionally, because the true label is known, the gradient in (6) and the loss can even be designed to be functions of the actual label value beyond the gradient dependence on the label through the link function; for example, a different link function can be used for a different label.

Examples of link functions include the identity, the sigmoid, and the exponential function

$$h ( z ) = z , \qquad ( 8 )$$

$$h ( z ) = σ [ α ( z + γ ) ] = \frac{1}{1 + {e}^{- α ( z + γ )}} ,$$

$$h ( z ) = exp ( α ( z + γ ) )$$

The respective primitive functions are the square, the Softplus function and the exponent,

$$H ( z ) = \frac{{z}^{2}}{2} , \qquad ( 9 )$$

$$H ( z ) = \frac{1}{α} \cdot log ( 1 + {e}^{α ( z + γ )} ) ,$$

$$H ( z ) = \frac{1}{α} \cdot {e}^{α ( z + γ )}$$

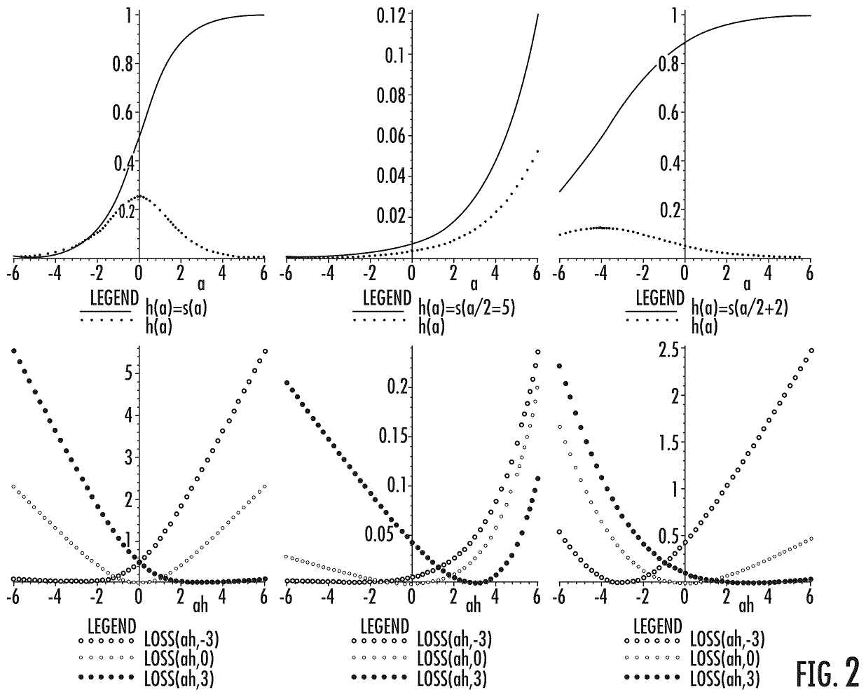

For the Sigmoid and the exponent, the parameters α and γ can determine on which region of the Sigmoid or exponent the loss focuses for the domain on which z is defined. On the other hand, a shift of γ can determine the behavior of the loss in different regions, as illustrated in FIG. 2.

Specifically, FIG. 2 shows three different shifts of the Sigmoid on the top, and matching loss curves for each of these (on the bottom) for three (label) activation values a E {−3, 0, 3}. The left link function (the standard unshifted Sigmoid) has a steep change in the center. This gives a strongly convex loss for the true label a=0. Due to the flat (noncompetitive) links on the left and the right, the losses to the left of a=−3 and to the right of a=3 are almost flat (as for the standard Sigmoid). Similar behavior is to the other side initially, but as we move farther to the other side, the loss increases due to transitioning through the steep region of the link. For the middle link, the loss for the large activation a=3 is large on both sides, due to the fast exponential increase of the link function. Losses for a=0 and a=−3 gradually become flatter around the minimum due to the gentler slopes in those regions. For the concave link on the right, the loss for a=−3 is steep, and as we move right, a mirror image of the behavior observed for the middle link is observed. The convex link in the center gives a larger loss to the right of the minimum at a=3 than the loss to its left. The concave link on the right is more sensitive to erring to the left of the minimum.

An important result of the behavior shown is that with exponentially increasing link functions losses can be designed that focus heavily on distinguishing between large label values (or activities), and between large values and small ones. Yet, they can discount distinguishing among small label values. There can be a biased distribution of examples, where many examples have small labels. These labels become less distinguishable among themselves, but their presence calibrates the overall loss, by anchoring it to the low activity labels so that the low activity examples are not predicted as having high activity. The loss then distinguishes well between high activity labels, and between high and low activity, but not among low activities.

This property can be leveraged for the retrieval problem. This behavior also differentiates asymmetric matching losses from losses which just scale the loss either by the true label, or by its estimate, for example, with a square loss. Scaling by the label value distinguishes well among high labels, and not between low labels. However, unlike an asymmetric matching loss, it does not suppress a high prediction of a low label. Scaling by the estimated label also distinguishes well in the high and not in the low value populations, but does not enhance the loss on a low estimate of a high true label. Matching losses can also be combined with either of these scalings.

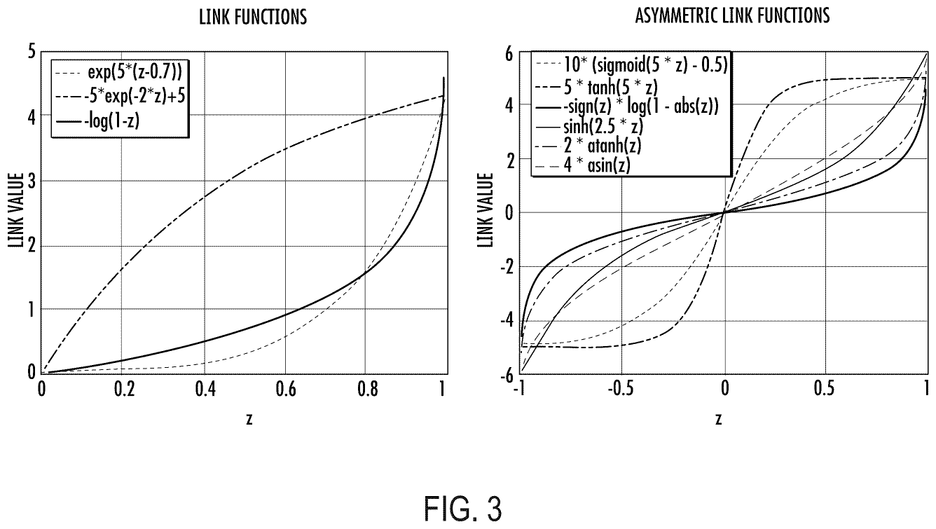

FIG. 3 graphs several link functions (which are scaled and shifted to fit the same axes). On the left, monotonic gradient link functions (scaled and shifted) for e^{z}, −log(1−z), and −e^{-z} are shown. These links can be used to enhance losses in regions of high slope, and suppress regions of low slope. The convex ones emphasize the larger activation values. The concave one −e^{-z} flattens out at high activations, and can be used to limit the control of the growth of the estimate at the top of the high range. In the large slope range, it can give a similar behavior to the exponential link, except that the loss to the right of the true label becomes smaller than that to the left. Thus it can penalize underestimation better than the exponential curve, which penalizes overestimation higher.

On the right of FIG. 3, example asymmetric link functions of σ(z), tan h(z), −sign(z)·log(1−α|z|), sin h(z), arctan h(z)=(½)[log(1+z)−log(1−z)], and arcsin (z) are shown. The Sigmoid and the hyperbolic tangent are identical with correct scaling and shifting. Their competitive (high gradient) region is in the center. The center can be matched by shifting and scaling to the important activation region. The flatter regions at the extreme can help keep labels in a limited region suppressing outliers. The other functions enhance the extremes, enabling losses that directly emphasize high values, or extreme values, but also potentially benefitting from other mechanisms to limit the exponential growth, such as clipping if necessary. The asymmetry of these curves can be useful for pairwise losses, where the magnitude of the label determines the sensitivity of the loss and not just its value.

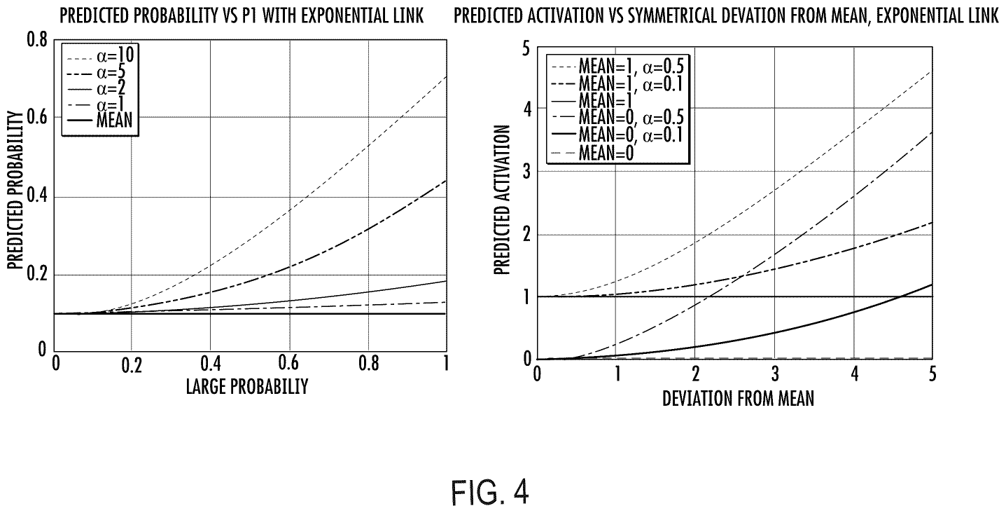

FIG. 4 demonstrates how an exponential link focuses on large label values, introducing bias (which can be helpful) to prediction. On the left, a population of labels with a single large label is observed, and potentially many small labels from two possible label values. The low label (probability) is 0.05, and the large label is greater, and takes the value of the x-axis. As the larger label value increases, the number of examples with the small label value increases (from 1 to 18), keeping the mean at 0.1. Applying an exponential link to the loss gives an estimate that increases with the larger probability. The higher that the scaling factor α is, the larger the deviation from the mean. In cases where the small label value is considered unimportant, this behavior gives more emphasis to the certain high label value, especially if there are many “bad” unimportant labels, which we want to discount. On the right, the mean is kept fixed between two label values, one that goes down and the other that goes up by some fixed deviation from the mean shown on the x-axis. As the deviation from the mean increases, the larger label becomes larger and dominates the loss more, giving a prediction that increases as a function of the deviation. The increase is faster with a higher temperature α. This is shown for two different mean values. This also illustrates the shift parameter γ in (9). The shift changes the loss scale, but is fixed for all input values, and thus does not change the expected minimum of the loss.

The examples in FIG. 4 are in a stochastic setting where the same item is labeled with different labels with some probability. Consider a more deterministic setting, in which each item has a label. Consider a case where each item has two different features, which attain different values for each example. One feature is responsible to distinguish well between low label values, and does not add any distinction between examples with high label values. The other does the opposite, with different values of the other feature, different high label values are obtained, but it does not contribute to distinguishing between low label values. In this setup, applying an exponential link will emphasize the loss between high label values, and discount the loss between low label values. This will lead to ignoring the first feature, and promoting the second feature that distinguishes among examples with high label values. A model trained with an exponentially linked asymmetric matching loss will be able to distinguish between examples with the high label values, but not between examples with the low ones. For optimizing NDCG, this is a desired property. In the scenario described, the property learned by the model will improve the NDCG metric.

### Example Multiclass Matching Losses

The concept of an asymmetric matching loss can be generalized to the multiclass setting with n-dimensional links, with each dimension being a function of n dimensions. A generalized Softmax link with scaling of and shifting of for the vector z=(z₁, z₂, . . . , zₙ) can be defined as

$$H ( z ) = \frac{1}{α} log \{ {\sum }_{k = 1}^{n} {e}^{α ( {z}_{k} + γ )} \} \qquad ( 10 )$$

where H(z) is a function of an n-dimensional vector, whose derivative with respect to the kth component is given by the kth dimension link function

$${h ( z )}_{k} = \frac{\partial H ( z )}{\partial {z}_{k}} = \frac{{e}^{α ( {z}_{k} + γ )}}{{\sum }_{ℓ = 1}^{n} {e}^{α ( {z}_{ℓ} + γ )}} \qquad ( 11 )$$

A matching loss, matching vector â to vector a is given by the Bregman divergence

$${L}_{match} ( \hat{a} , a ) = D ( \hat{a} , a ) = \frac{1}{α} log \{ {\sum }_{k = 1}^{n} {e}^{α ( {\hat{a}}_{k} + γ )} \} - \frac{1}{α} log \{ {\sum }_{k = 1}^{n} {e}^{α ( {a}_{k} + γ )} \} - {\sum }_{k = 1}^{n} ( {\hat{a}}_{k} - {a}_{k} ) \cdot \frac{{e}^{α ( {a}_{k} + γ )}}{{\sum }_{ℓ = 1}^{n} {e}^{α ( {a}_{ℓ} + γ )}} \qquad ( 12 )$$

Again, the matching loss can be defined directly with its gradient, where the derivative relative to the kth component is given by

$$\frac{\partial {L}_{match} ( \hat{a} , a )}{\partial {\hat{a}}_{k}} = {h ( \hat{a} )}_{k} - {h ( a )}_{k} \qquad ( 13 )$$

The generalized Softmax in Equations (10)-(13) reduces to a standard Softmax with α=1 and γ=0, with the link h(a) expressing the vector of Softmax probabilities of all the classes. Equations (12)-(13) give a distillation loss and its gradient for matching multiclass soft probabilities. With a temperature α≠1 and a shift γ≠0, similar mappings to those of the binary case can be applied to the Softmax to specifically focus on regions of the activations. The approach in (10)-(13) is also extendible to wider definitions of the Softmax function.

### Example Asymmetric Matching Losses for NDCG

In Equation (8), several examples of monotonically increasing (or monotonically non-decreasing) link functions were shown. The identity and Sigmoid are particularly useful. Specifically, as shown in FIG. 2, a section of the Sigmoid can be matched to the region of interest by shifting and scaling the Sigmoid. In the case of retrieval, a segment of the Sigmoid can be mapped to the range [0, L]. Mapping the exponential growth part of the Sigmoid in the top center of FIG. 2 gives an asymmetric loss that focuses on high grades. However, it can be simpler to use a link that is already exponential in the positive quadrant, as

$$h ( z ) = {e}^{α ( z - γ )} , \qquad ( 14 )$$

$$h ( z ) = - α log ( 1 - \frac{z}{L + 1} ) ,$$

$$h ( z ) = {2}^{z} - 1 ,$$

$$h ( z ) = {2}^{z - L} - 1$$

The last two functions are the gain function of the exponential NDCG metric, or the gain normalized by the gain of the largest grade (for numerical stability).

Consider the ground truth relevance label yᵢ and the relevance score sᵢ that a model assigns to the item. Since the loss can be applied in a pointwise manner to each item in a list of items, we can drop the subscript i for brevity. In general, a matching loss can be applied to match activation values, denoting the one to be matched as a and the one matched as â. For the ranking problem, some example implementations can use the relevance label y and match the relevance score s predicted by the model to it. Using the ranking convention, the matching loss in (7) is defined as

$$L ( s , y ) {=}^{△} {\int }_{y}^{s} [ h ( z ) - h ( y ) ] dz \qquad ( 15 )$$

As shown in FIG. 1, the loss computes the area that the function beyond its value at the true label covers in the interval between the true label and the predicted score. If the function's growth rate is high around the label or around the predicted score, the loss increases. If both y and s are within a flatter region, the loss is small. Using the exponential retrieval link function, the loss is aligned with the retrieval metrics that do not attempt to penalize low relevance labels if predicted as low relevance, but penalize incorrect predictions which predict high relevance or of high relevance labels.

A big advantage of the matching loss is that the gradients with respect to the learned score can be simply given by the link function difference

$$g ( s , y ) = h ( s ) - h ( y ) \qquad ( 16 )$$

This, again, makes training more sensitive in regions where the link function exhibits fast growth. Thus, if one wants a model to be more accurate for some label regions, designing a link function that is fast changing within that region can achieve that goal.

For optimizing NDCG, the NDCG gain function is natural to use with the asymmetric loss. For the linear NDCG scores, the linear link function can be used, giving the score to label difference as the gradient, which is similar to square loss. For the exponential NDCG in (3), using the gain function from (14) is natural. (However, because this link does not fully characterize the NDCG metric, using other links with similar properties can also lead to comparable results.) With the gain function link, the loss is

$$L ( s , y ) = \frac{1}{ln 2} ( {2}^{s} - {2}^{y} ) - ( s - y ) \cdot {2}^{y} \qquad ( 17 )$$

and its gradient is given by

$$g ( s , y ) = {2}^{s} - {2}^{y} \qquad ( 18 )$$

For numerical stability, example implementations can normalize the loss and the gradient by the maximal relevance label that may be observed, giving

$$L ( s , y ) = \frac{1}{{2}^{L}} \cdot \{ \frac{1}{ln 2} ( {2}^{s} - {2}^{y} ) - ( s - y ) \cdot {2}^{y} \} \qquad ( 19 )$$

$$g ( s , y ) = \frac{1}{{2}^{L}} \cdot ( {2}^{s} - {2}^{y} )$$

The asymmetric loss in equation (19) targets matching the CG gain predicted by the model to that of the true relevance labels, emphasizing on matching the higher relevance labels, and discounting matching of the lower relevance labels, unless predicted as higher relevance. An exponential (or similar) link focuses the loss in the following order: first on over and underestimating high label values, second on overestimating low label values, and last on underestimating low label values. This achieves the goals of optimizing NDCG, despite ignoring the discount factors. Ignoring the discount factors allows the loss to be applied as a pointwise loss, without need to explicitly consider the relations to other items on the list, reducing the complexity to linear instead of quadratic in the number of items in the list of items.

Matching the true labels also makes the loss aware of actual label values, as opposed to pairwise techniques like LambdaRank. Pairwise relations eliminate features common to items in a pair that may influence the values of actual relevance levels. LambaRank partially corrects that by weighing the loss by the gain difference, but that difference is still normalized by maxDCG. Instead of using such surrogates, the asymmetric loss weighs exactly by the gain that optimizes metrics like NDCG. Weighing by the gain as LambdaRank may not be sufficient, for example, in cases in which items have identical labels. LambdaRank would omit such items from the optimization. Consider, for example, a case where two items show with an identical label in one list, and with a different identical label in other lists. LambdaRank will exclude the relation between these items from the loss, and if they are the only items in the list, the list will have no loss. An asymmetric matching loss will still optimize to find good predictions for the label values. Now, assume that the training set contained many lists of different items with identical labels, but now the model needs to rank items from different training lists. The pairwise losses will not have learned any predictions for such cases, but the pointwise matching loss in (19) not only learned absolute label predictions for the items in the training lists, but also predictions that can rank the items in a way that optimizes metrics as NDCG. If the labels in a whole list are shifted from one list to another, keeping the differences constant, pairwise losses, including LambdaRank, will treat the lists as identical lists (due to the maxDCG normalization). The loss in (19) will not, as it attempts to match the actual labels.

A pointwise asymmetric matching loss thus has the following advantages over pairwise methods like LambdaRank when optimizing NDCG:

It does not require a pairwise implementation, thus has linear complexity in the size of the list instead of quadratic.

It is label value aware even if pairwise training data is not fully available, thus aligned better with the gain in the NDCG metric.

It can train on unranked items, does not require items to be in lists, and can train on lists of variable sizes.

It is robust to list label shifts, still providing label value predictions aligned with the evaluation metrics.

With these advantages, an asymmetric matching loss produces rankings that can be used to rank lists better than standard pointwise losses that do not optimize for metrics like NDCG, which care more about high scores.

### Example Illustration of Example Pointwise Approach

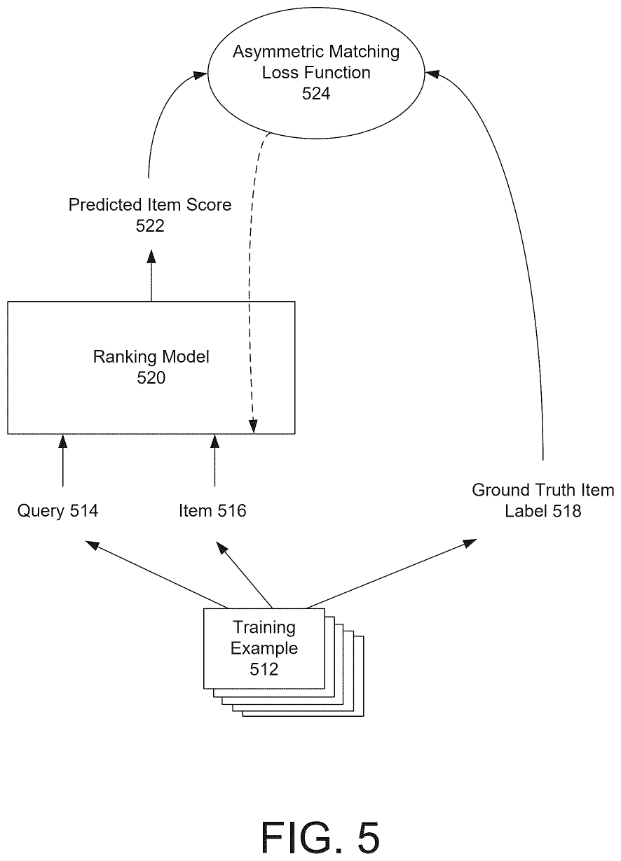

FIG. 5 illustrates a schematic diagram of a computer-implemented method for training a machine-learned ranking model 520. FIG. 5 illustrates how a training example is used to refine and optimize the ranking model (520) through the evaluation of an asymmetric matching loss function 524.

The diagram begins with a training example 512, which includes data descriptive of an item 516 and a corresponding label value 518. This label value 518 represents the ground truth relevance of the item, which is the target for training the ranking model 520 to accurately predict item scores. In some implementations, the training example 512 also includes data descriptive of a query 514. In this case, the model is designed to assess the responsiveness or relevance of the item 516 relative to the specific query 514.

The item 516 and the query 514 can be provided as input to the ranking model 520. The model 520 processes this data to generate a predicted item score 522. For example, the score 522 can be an output that estimates the relevance of the item 516 to the query 514.

The asymmetric matching loss function 524 forms a feedback loop with the ranking model 520. The loss function 524 evaluates the predicted item score 522 and the ground truth label value 518 using a monotonically-increasing link (or monotonically non-decreasing) function. Specifically, the asymmetric matching loss function 524 can evaluate an area under a monotonically-increasing link (or monotonically non-decreasing) function from the label value 518 to the predicted item score 522.

To update the parameters of the model 520, the gradient of the loss 524 can be computed and backpropagated through the model 520. For example, the parameters can be updated using an optimization algorithm such as stochastic gradient descent, where each parameter is adjusted to reduce the loss 524. This process can be iterated multiple times, allowing the model 520 to refine its predictions to align more closely with the ground truth labels, thus optimizing the model's performance for better ranking accuracy on unseen data.

### Example Extensions

Discounts and Scaling: The loss in (19) can be modified in several ways. To keep contributions of each list (or query) to the overall objective equal, (19) can be normalized by maxDCGn and applied only on the top n items ranked by the model. However, this may not be ideal if the items with the largest true labels are not selected by the model in the top n. Normalizing by maxDCGn also restricts the loss to optimize only for lists with n items. One advantage of (19) over LambdaRank is that it gives identical optimization regardless of the number of ranked items. Other approaches to scale or discount the loss include: discounting by the ratio DCG/maxDCG, discounting by the ratio between minDCG and maxDCG, and adding the NDCG position discount of either the true position or the predicted position.

Label Noise Resistance: For many problems the labels may be subjective. Users or raters may shift or scale relevance labels differently. Some variance on the relevance grade is expected. Link functions can be designed to smooth such label variance. Flat regions in the link can be used to keep the loss small between adjacent relevance grades. This imposes different curves per each label. For example, for label y, we can assume that some users are likely to give scores of y−1 and y+1 to the same item. We may not want to penalize such scores. Imposing a flat segment of the link in the interval [y−1, y+1] will not impose loss within this interval. Prediction of a grade in this interval will impose no loss. Outside the interval, however, the link can have an exponential curve, again, emphasizing the higher true labels and predictions. Using h_{y}(z)=sin h(z−y), or a similar link, can impose an almost flat interval around y with exponential growth to its sides. For large losses only to the right, some example implementations can use a piecewise exponential function with a piece around y with a small or 0 slope. Another alternative is a zigzag linear link, with 0 slope in regions of label uncertainty, and linear slope anywhere else. This gives a flat minimum surrounded by quadratic curves.

Capping Loss at Large Labels: A link h(z)=−e^{L-γ-z}, where γ ensures numerical stability, and L is the maximal label value, limits the overestimation loss for high labels. This is useful for numerical stability. It also ensures that for high labels underestimation costs more than overestimation, which is sometimes desirable. As long as the slope in the region of large labels is high enough, using a concave link can still give good properties at the large slope region. To ensure discounting low scores, a section of a Sigmoid can be used as in FIG. 2. This also guarantees capping losses for large labels.

Per Label or Per Activation Links: Using per-label links is not limited only to label noise robustness. Per label links can be used to tune the sensitivity according to the system designs, and the expected label distribution. Less important label values can be suppressed, while more important ones enhanced. Similarly, links can be functions of the predicted label (the activation).

Non-analytical Loss Functions: The matching loss framework defines losses through their gradients via the link function. This gives freedom to defining link functions for which there is no analytical expression for the actual loss. For example, h(z)=exp[α(σ(z)+γ)], where σ(⋅) is the Sigmoid function. This link can give behavior like that of a Sigmoid, but scaled up. It can focus on high grades, discounting low ones, when grades can be large (for example, L=10), yet, can numerically cap the loss.

### Example Pairwise Matching Losses

A pairwise asymmetric matching loss can be designed in a similar manner to a pointwise one. In the pairwise setup, though, the loss matches the learned score difference to the true label difference. The asymmetry can enhance differences with large magnitudes and discount small differences. Small differences can be considered to be within the noise caused by user or rater subjectiveness. For the pairwise case, example implementations can use asymmetric link functions h(z)=−h(−z). Then, the loss is defined by its gradient, which is given by

$$\frac{\partial L ( y , s )}{\partial {s}_{i}} = {\sum }_{j \neq i} [ h ( {s}_{i} - {s}_{j} ) - h ( {y}_{i} - {y}_{j} ) ] \qquad ( 20 )$$

The asymmetry of the link function around 0 gives robustness to the order of any pair. The gradient with respect to s; can be expressed the same way for every element j in the sum of (20) whether sᵢ>sⱼ, sᵢ<sⱼ, or sᵢ=sⱼ. This would not be possible with link functions that are not asymmetric around 0. Unlike other pairwise losses, a loss can be applied even if the labels yᵢ and yⱼ are equal, simply attempting to match the equality in the labels to equality in the scores. A variation of (20) can express a loss that ignores equalities. However, conceptually matching equalities pushes items with equal labels to predict equal labels, which is a desired behavior.

In some applications, raters or users may give pairwise graded labels (preference) ranking between item pairs, instead of giving relevance scores for each of the items. The label difference yᵢ−yⱼ can be replaced by a pairwise label yᵢⱼ. However, the learned scores may still be individual per item scores.

Matching score differences to grade differences may be more robust to the actual graded labels, to shifts in label scale, and to the list size, specifically if more items are added in various additional positions in the list. It thus may generalize better when ranking lists that differ from those in the training data. Using the loss in (20) can reduce the effect of user or rater variance, and specifically of different skews of different ranked lists that depend on the persons who rated the lists. Standard pairwise learning to rank losses have similar properties, but do not account for the gain and discount of metrics like NDCG. LambdaRank, on the other hand, does account for these gains and discounts, but is not fully robust to skews. The asymmetric matching loss formulation gives a fully shift-robust framework that also accounts for the gain with exponentially increasing link functions. Like other pairwise losses, training on score differences drops the effect of features common to both items in the pair.

The inclusion of 0 label difference in the loss matches equal scores to equal labels. The amount of matching depends on the link function. A flat link around 0 with steep links at high magnitudes would lead to matching the scores only if their differences are large. Small differences will be discounted, also making the loss robust to small label noise. A steep link around 0 will enhance matching equal scores.

The choice of the link function dictates the loss. Links whose gradients become steeper with larger magnitudes, such as the hyperbolic sine and similar functions as shown in FIG. 3, will focus on predicting large differences, and discount smaller differences. They will penalize over- and underestimation of large differences and overestimation of small differences, but will only weakly penalize underestimation of small differences. Links like a 0-centered hyperbolic tangent or Sigmoid will penalize under and over estimation of small differences, as well as underestimation of large differences, but will weakly penalize overestimation of large differences. Thus, they will focus on pushing predictions of equal labels to be equal.

### Example Illustration of Example Pairwise Approach

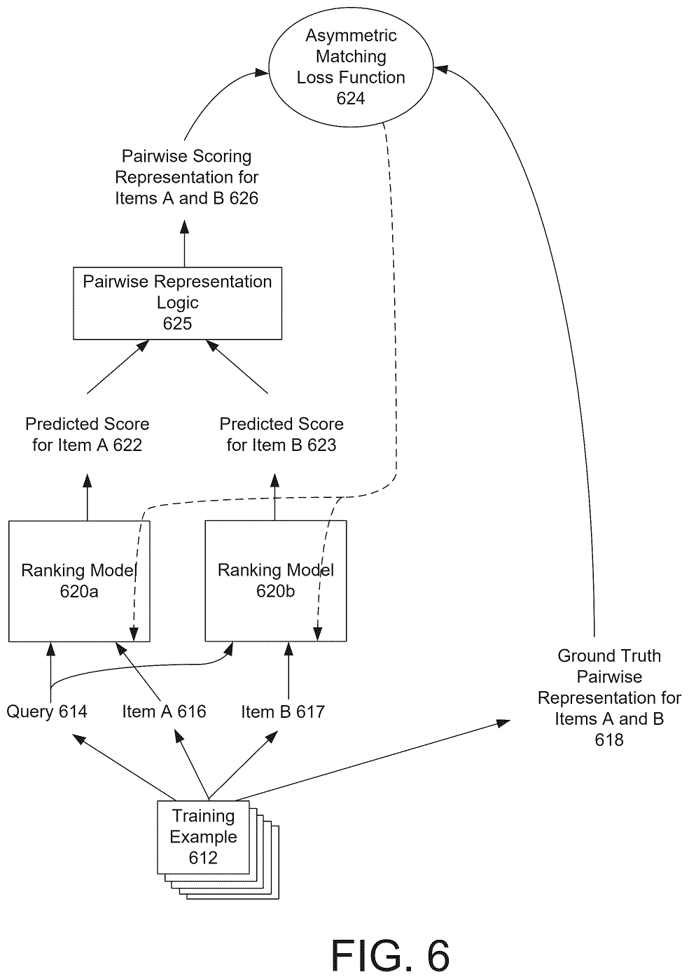

FIG. 6 illustrates a block diagram of an example pairwise training approach according to example embodiments of the present disclosure.

In particular, FIG. 6 illustrates a training example 612 that includes data descriptive of a first item 616 and a second item 617, along with one or more label values respectively associated with these items 618. The training example 612 may also include data descriptive of a particular query 614.

The training example 612 can also include one or more ground truth label values associated with the first item 616 and the second item 617. As one example, the one or more ground truth label values can include first and second label values respectively associated with the first and second items. For example, the ground truth label values can be pointwise label values. In another example, the one or more ground truth label values can include a preference label for the first and second items. The preference label may be a single label that indicates a preference between the first item and the second item.

A ground truth pairwise representation 618 can be generated from the one or more ground truth label values. As one example, ground truth pairwise representation 618 can be a difference between the first label value and the second label value. In another example, the ground truth pairwise representation 618 can simply be the preference label.

Referring still to FIG. 6, the system processes the data for the first item 616 (and optionally also the query 614) with a first instance of the ranking model 620a to generate a first predicted item score 622. Similarly, the system processes the data for the second item 617 (and optionally also the query 614) with a second instance of the ranking model 620b to generate a second predicted item score 623. The instances of the model 620a and 620b may be a single instance or may be two different instances.

The predicted scores for both items can be in the form of logit scores or probabilities, depending on the specific implementation and requirements of the ranking model 620a, 620b. This flexibility allows the system to adapt to different types of input data and scoring requirements.

A pairwise scoring representation 626 for the two items is generated based on these scores (e.g., via application of pairwise representation logic 625). As one example, the pairwise scoring representation 626 can be a difference between the first predicted item score 622 and the second predicted item score 623. As another example, the pairwise scoring representation 626 can be some other form of preference score generated or derived from the first predicted item score 622 and the second predicted item score 623.

The system can evaluate an asymmetric matching loss function 624 that computes an area under a monotonically-increasing (or monotonically non-decreasing) link function from the pairwise label representation 618 to the pairwise scoring representation 626.

The link function used in evaluating the asymmetric matching loss 624 can vary. For example, in the pairwise case it can be an asymmetric function. As another example, the link function can be a standard hyperbolic sine function or another similar function that has been scaled and/or shifted to fit specific modeling needs. Alternatively, the link function can be a standard Sigmoid function or a Sigmoid function that has been modified by scaling and/or shifting, allowing for flexibility in how the model responds to differences in item scores.

Furthermore, in some implementations, the link function employed in the asymmetric matching loss 624 may be an odd function that is symmetric about the origin, ensuring robustness and consistency in how score differences are handled, regardless of their direction or magnitude. This symmetry helps in maintaining model stability and accuracy across varying data sets and scoring scenarios. For example, in the pairwise case, an odd or asymmetric link function can improve the robustness with respect to the order in which the items appear.

To update the parameters of the model 620, the gradient of the loss 624 can be computed and backpropagated through the model 620. For example, the parameters can be updated using an optimization algorithm such as stochastic gradient descent, where each parameter is adjusted to reduce the loss 624. This process can be iterated multiple times, allowing the model 620 to refine its predictions to align more closely with the ground truth labels, thus optimizing the model's performance for better ranking accuracy on unseen data.

### Example Listwise Matching of Max DCG

The matching losses described in Equations (14)-(19) focused on matching the learned ranking scores to the relevance labels without directly attempting to maximize list NDCG scores. It turns out, however, that matching losses can, in fact, be used to attempt to match the maximal DCG scores for all items in a list of n items. This section starts with describing such matching for the case where optimization assumes that all lists are of n items, constraining the optimization to match maxDCGn. It is then shown that this approach gives a loss that can be easily modified to be used even without constraining to lists of n items.

Let σₘ be a permutation of the n indices for which the order of the true labels is decreasing (or at least non-increasing). The identity permutation used to define DCGₙ in (2) takes the order dictated by the predictions of the model, where items are ordered in decreasing order of prediction scores sᵢ. Thus σₘ(1) gives the index in the model ranking of the item for which the true label is the largest. (Using this convention is consistent with early definitions in this document. In general we can also interchange the convention where the unpermuted order is according to the true labels.) MaxNDCGₙ is then defined as

$$M {=}^{Δ} max {DCG}_{n} = {\sum }_{i = 1}^{n} \frac{{2}^{{y}_{{σ}_{m} ( i )}} - 1}{{log}_{2} ( i + 1 )} \qquad ( 21 )$$

Unlike (2), in which the items are ordered by their retrieval position and not their label order, the numerator decreases with i and the denominator increases with i. Thus both decrease the summand as i increases, (or at least make it nonincreasing for equal labels).

Now, define the predicted DCG aggregate score with scores sᵢ but with the discounts of the best true ordering σₘ (reversing the roles in Equation (2), in which DCG is defined with the true labels but the ranking of the model, now we use the model scores with ranking of the true labels),

$$S {=}^{Δ} {\sum }_{i = 1}^{n} \frac{{2}^{{s}_{{σ}_{m} ( i )}} - 1}{{log}_{2} ( i + 1 )} \qquad ( 22 )$$

The goal is now to match S to M and the scores to the labels by defining a matching loss that matches sᵢ to yᵢ (or more accurately s_{σ}_{ₘ}₍ᵢ₎ to y_{σ}_{ₘ}₍ᵢ₎). Because both M and S are (weighted) sums of exponents, this implies some generalized form of a Softmax function as described in (10)-(13). Such a generalization can be attained by applying a similar equation to (10) on S and M, giving

$$H ( z ) {=}^{Δ} log \{ {\sum }_{i = 1}^{n} \frac{{2}^{{z}_{{σ}_{m} ( i )}} - 1}{{log}_{2} ( i + 1 )} \} \qquad ( 23 )$$

Differentiating with respect to the σₘ(i)-th component of the activation vector gives

$${h ( s )}_{{σ}_{m} ( i )} = \frac{\partial H ( s )}{\partial {s}_{{σ}_{m} ( i )}} = \frac{1}{S} \cdot \frac{{2}^{{s}_{{σ}_{m} ( i )}}}{{log}_{2} \{ e \cdot ( i + 1 ) \}} \qquad ( 24 )$$

This gives a listwise matching loss of

$$L ( s , y ) = log S - log M - \frac{1}{M} \cdot {\sum }_{i = 1}^{n} ( {s}_{{σ}_{m} ( i )} - {y}_{{σ}_{m} ( i )} ) \cdot \frac{{2}^{{y}_{{σ}_{m} ( i )}}}{{log}_{2} \{ e \cdot ( i + 1 ) \}} \qquad ( 25 )$$

The gradient of the matching loss with respect to the σₘ(i)-th component of the score vector is given by

$$\frac{\partial L ( s , y )}{\partial {s}_{{σ}_{m} ( i )}} = \frac{1}{S} \cdot \frac{{2}^{{s}_{{σ}_{m} ( i )}}}{{log}_{2} \{ e \cdot ( i + 1 ) \}} - \frac{1}{M} \cdot \frac{{2}^{{y}_{{σ}_{m} ( i )}}}{{log}_{2} \{ e \cdot ( i + 1 ) \}} \qquad ( 26 )$$

The gradient of the loss in (26) doubly focuses on matching the larger labels. First, the exponential expression imposes larger losses for larger labels encouraging matching the scores of such labels. This discounts scores of smaller labels, and leads to the benefits of asymmetric losses, discussed earlier, which penalize inaccurate predictions of larger labels and overestimation of small labels, but discount inaccurate underestimation or small overestimations of small labels. Second, the loss for the largest label is discounted the least. Discounts are then ordered increasingly with decreasing the true labels. Thus losses for larger labels are weighted higher than losses for smaller ones.

Softmax and the generalized Softmax that emerges from (23) give a degree of freedom. In (26) this degree of freedom carries over to a normalizer of a learned max DCG relative to the true one. The gradient in (26) can lead to a set of scores whose gain-discount product is scaled by S/M relative to the maximum DCG score. This gives some flexibility in learning the ranking scores among different lists in which items receive different relevance labels (that can be shifted by user subjectivity noise), where each list has a different max DCG. Alternatively, to push the loss to ensure that the ranking scores match the true labels, an additional loss component can be added and applied in addition to (25)-(26) to match S to M. A square loss will apply the matching with an identity link, giving

$$\frac{\partial L ( S , M )}{\partial S} = S - M \qquad ( 27 )$$

The loss adds constraints on all components of the score vector s. To focus on larger scores, a matching loss with an increasing focus on larger values can replace (27), for example,

$$\frac{\partial L ( S , M )}{\partial S} = {e}^{α ( S + γ )} - {e}^{α ( M + γ )} \qquad ( 28 )$$

The loss in (25)-(26) pushes the ranking scores to match the order of the true labels, giving a degree of freedom for scaling the predicted value of max DCG. Such a degree of freedom may not be necessary. Removing the normalization of the link function by max DCG removes this freedom, and keeps matching the ranking scores to the labels with double emphasis on matching the larger labels through both the gain and the discount. Such a loss also removes the dependence of the loss on the number of items in the list n through the max DCG term. Thus, a matching loss that includes an NDCG per-position discount scaling (as discussed earlier following (19)) can be obtained from the analysis described above to match max DCG. Its gradient is given by

$$\frac{\partial L ( s , y )}{\partial {s}_{{σ}_{m} ( i )}} = \frac{{2}^{{s}_{{σ}_{m} ( i )}}}{{log}_{2} \{ i + 1 \}} - \frac{{2}^{{y}_{{σ}_{m} ( i )}}}{{log}_{2} \{ i + 1 \}} \qquad ( 29 )$$

The exponent of the loss in (29) can be further scaled (and shifted) to change the emphasis regions by

$$\frac{\partial L ( s , y )}{\partial {s}_{{σ}_{m} ( i )}} = \frac{{2}^{α [ {s}_{{σ}_{m} ( i )} + γ ]}}{{log}_{2} \{ i + 1 \}} - \frac{{2}^{α [ {y}_{{σ}_{m} ( i )} + γ ]}}{{log}_{2} \{ i + 1 \}} \qquad ( 30 )$$

The discount terms can be adjusted to give identical discounts to items with equal labels, fixing the ranking position to all items with an equal label at that position.

An alternative approach to matching the scores directly to the labels is matching the scores directly to the gain-discount quotient, with some link function hₘ(z). This gives a gradient of a matching loss given by

$$\frac{\partial L ( s , y )}{\partial {s}_{{σ}_{m} ( i )}} = {h}_{m} \{ {s}_{{σ}_{m} ( i )} \} - {h}_{m} \{ \frac{{2}^{{y}_{{σ}_{m} ( i )}} - 1}{{log}_{2} ( i + 1 )} \} \qquad ( 31 )$$

An exponential function hₘ(z)=exp(α(z+γ)) would emphasize matching larger overall gains,

$$\frac{\partial L ( s , y )}{\partial {s}_{{σ}_{m} ( i )}} = exp \{ α ( {s}_{{σ}_{m} ( i )} + γ ) \} - exp \{ α \cdot ( \frac{{2}^{{y}_{{σ}_{m} ( i )}} - 1}{{log}_{2} ( i + 1 )} + γ ) \} \qquad ( 32 )$$

This approach may lead to losses that may not be expressible analytically. However, the gradients can be expressed as in (31)-(32).

The approach described in this section allows training matching scores (either to match the labels (25)-(30) or to match the gain-discount quotient (31)-(32)) matching both gain and discount, independently of the list size, allowing training on varying size lists. With this flexibility the losses directly optimize NDCG scores through using the position discounts of the true labels combined with the properties of asymmetric matching losses that can focus on matching the larger label values.

### Example Illustration of Example Listwise Approach

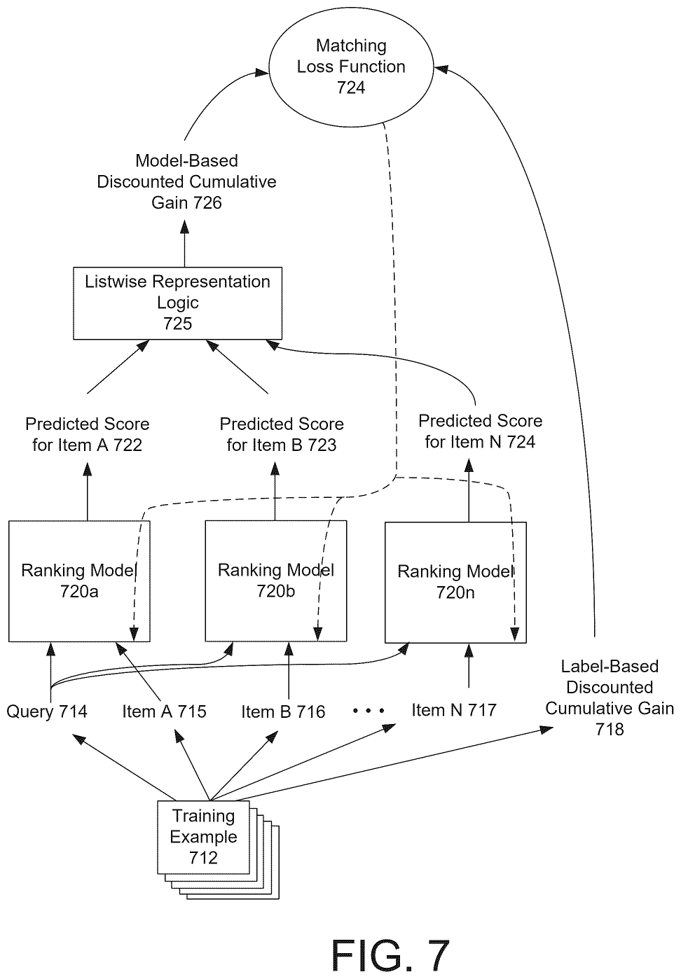

FIG. 7 illustrates a block diagram of an example listwise training approach according to example embodiments of the present disclosure.

A computing system can obtain a training example 712 comprising data descriptive of a plurality of items 715, 716, 717 and a plurality of label values respectively associated with the plurality of items. The training example 712 may also include data descriptive of a query 714.

The data descriptive of the plurality of items 715, 716, 717 is processed by the computing system using a machine-learned ranking model 720a, 720b, 720n to generate a plurality of predicted item scores 722, 723, 724 respectively for the plurality of items as outputs of the ranking models 720a, 720b, 720n. The ranking models 720a, 720b, 720n may be multiple distinct instances of the ranking model or may be a single instance of a ranking model that is configured to score multiple items at once.

A model-based discounted cumulative gain 726 is generated from the plurality of predicted item scores 722, 723, 724, and a label-based discounted cumulative gain 718 is generated from the plurality of label values. For example, listwise representation logic 725 can be applied to the scores 722, 723, 724 to generate the model-based discounted cumulative gain 726.

A matching loss function 724 evaluates a match between the model-based discounted cumulative gain 726 and the label-based discounted cumulative gain 718. The system can modify one or more values of one or more parameters of the machine-learned ranking model 720 based on the matching loss function 724.

In particular, in some implementations, for each index in a ranking ordering, the matching loss function 724 evaluates an area under a curve of a link function from the label value associated with the index to the predicted item score associated with the index. In another example, the matching loss function 724 can match the plurality of predicted item scores 722, 723, 724 to a gain-discount quotient.

### Example Devices and Systems

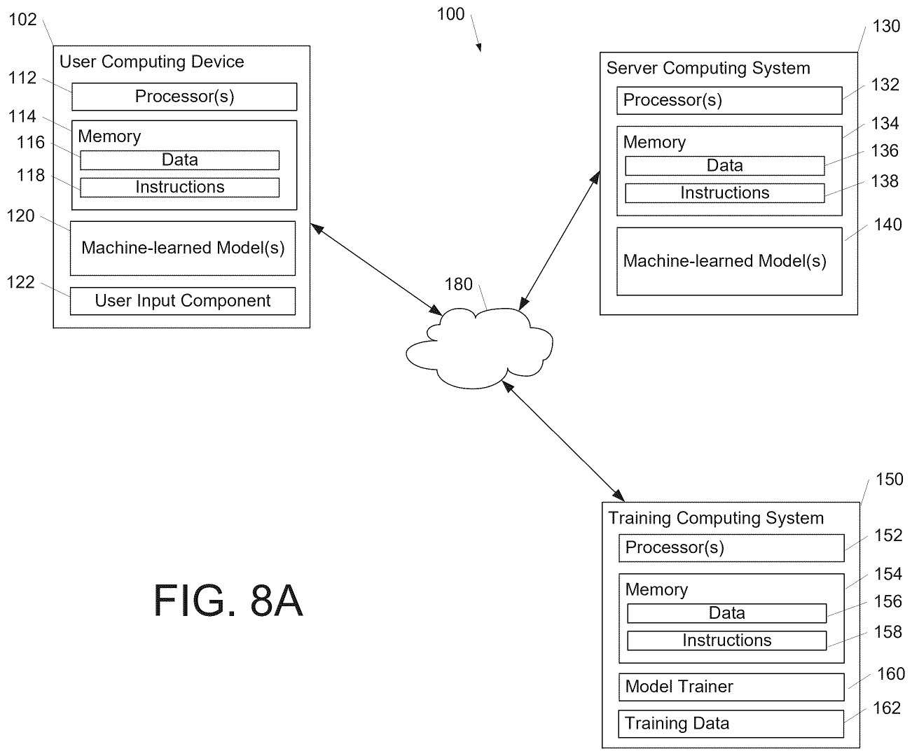

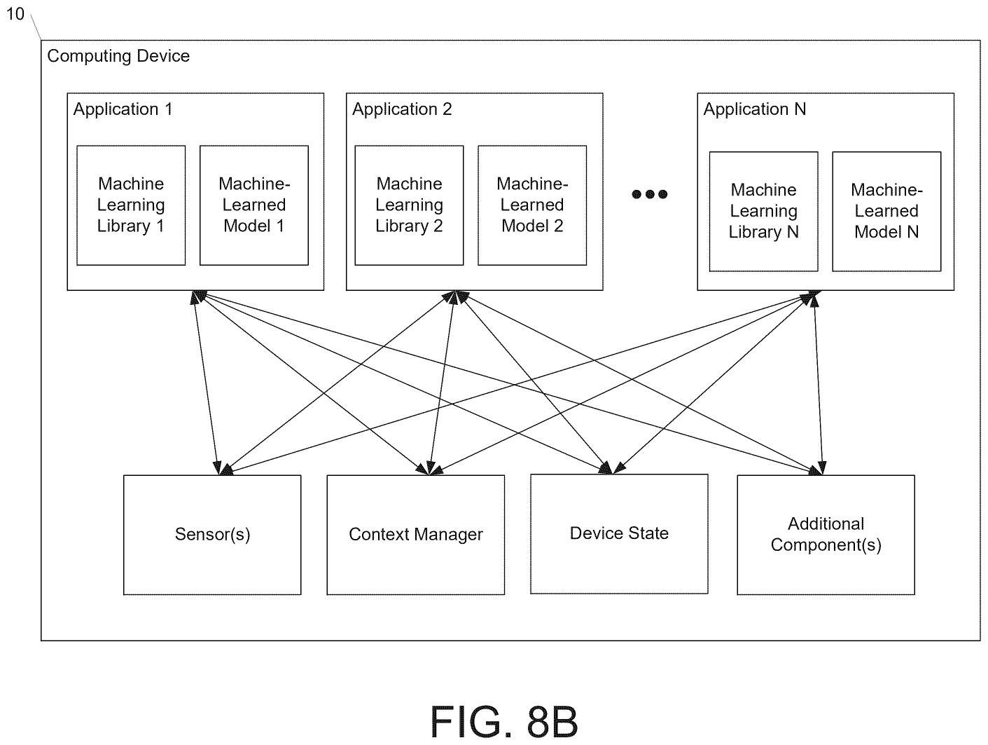

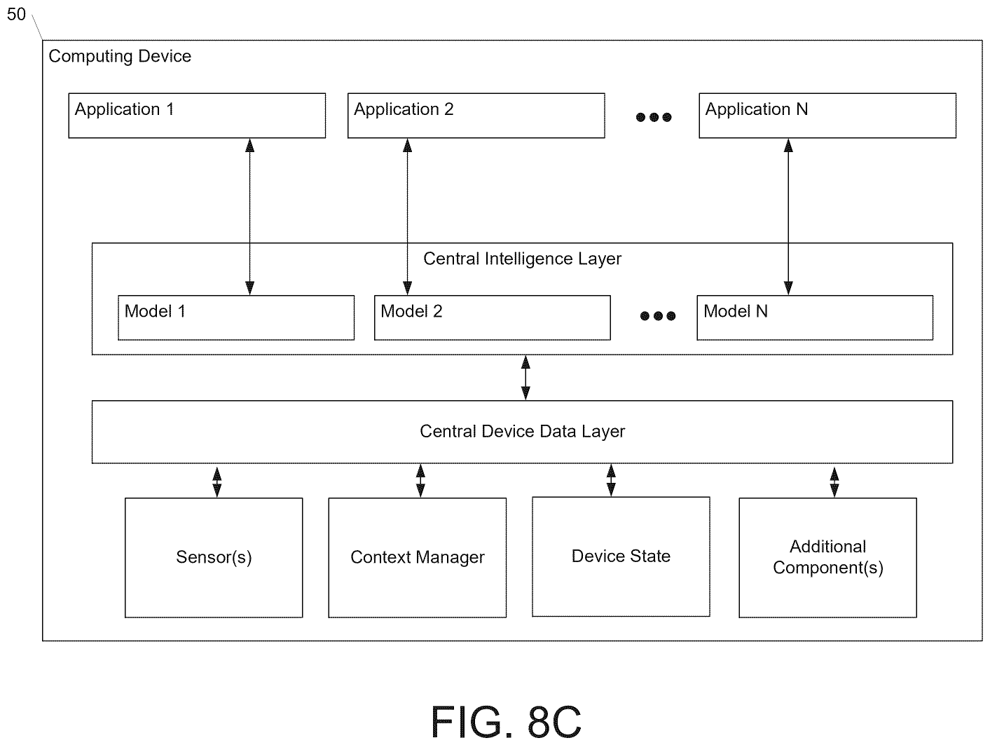

FIG. 8A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-7.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel ranking across multiple instances of queries).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an information retrieval service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-7.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, pointwise, pairwise, and/or listwise ranking and/or relevance data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 8A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 8B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 8B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 8C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 8C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 8C, the central device data layer can communicate with a number of other components of the computing device, such as, for example, one or more sensors, a context manager, a device state component, and/or additional components. In some implementations, the central device data layer can communicate with each device component using an API (e.g., a private API).

### Computer System Flexibility

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to train a machine-learned ranking model, the method comprising:
obtaining, by a computing system comprising one or more computing devices, a training example comprising: (i) data descriptive of an item and (ii) a label value respectively associated with the item;
processing, by the computing system, the data descriptive of the item with the machine-learned ranking model to generate a predicted item score for the item as an output of the machine-learned ranking model;
evaluating, by the computing system, an asymmetric matching loss function that evaluates an area under a monotonically-increasing or monotonically non-decreasing link function from the label value to the predicted item score; and
modifying, by the computing system, one or more values of one or more parameters of the machine-learned ranking model based on the asymmetric matching loss function.

2. The computer-implemented method of claim 1, wherein the link function comprises a standard exponential function or an exponential function that has been one or both of scaled and shifted.

3. The computer-implemented method of claim 1, wherein the link function comprises a standard Sigmoid function or a Sigmoid function that has been one or both of scaled and shifted.

4. The computer-implemented method of claim 1, wherein the link function comprises one or more flat regions where adjacent labels are not penalized by the loss function.

5. The computer-implemented method of claim 1, wherein the link function comprises a capped upper region.

6. The computer-implemented method of claim 1, wherein the loss function comprises two or more different link functions applied for different label values or different regions of predicted item scores.

7. The computer-implemented method of claim 1, wherein the link function is adjusted, scaled, or discounted using one or more quantities derived from a normalized discounted cumulative gain metric, and wherein the link is normalized by a maximum value of the normalized discounted cumulative gain metric or a discount applied to the normalized discounted cumulative gain metric.

8. The computer-implemented method of claim 1, wherein the asymmetric matching loss function is analytically inexpressible but a gradient of the asymmetric matching loss function comprises a difference in evaluations of the link function at the predicted item score and the label value, and wherein evaluating, by the computing system, the asymmetric matching loss function consists of determining, by the computing system, the gradient of the asymmetric matching loss function.

9. The computer-implemented method of claim 1, wherein:
the training example further comprises data descriptive of a query;
the item is a single item;
processing, by the computing system, the data descriptive of the item with the machine-learned ranking model to generate the predicted item score comprises processing, by the computing system, the data descriptive of the item and the data descriptive of the query with the machine-learned ranking model to generate a pointwise predicted item score; and
the pointwise predicted item score indicates a pointwise level of relevance for the single item relative to the query.

10. A computing system configured to train a machine-learned ranking model, the computing system comprising one or more processors and one or more non-transitory computer-readable media that collectively store computer-executable instructions for performing operations for pairwise training, the operations comprising:
obtaining, by the computing system, a training example comprising: (i) data descriptive of a first item and a second item and (ii) one or more label values respectively associated with the first item and the second item;
processing, by the computing system, the data descriptive of the first item with a machine-learned ranking model to generate a first predicted item score for the first item as an output of the machine-learned ranking model;
processing, by the computing system, the data descriptive of the second item with the machine-learned ranking model to generate a second predicted item score for the second item as an output of the machine-learned ranking model;
generating, by the computing system, a pairwise scoring representation for the first item and the second item based on the first predicted item score and the second predicted item score;
evaluating, by the computing system, an asymmetric matching loss function that evaluates an area under a monotonically-increasing or monotonically non-decreasing link function from a pairwise label representation to the pairwise scoring representation, the pairwise label representation comprising or being derived from the one or more label values respectively associated with the first item and the second item; and
modifying, by the computing system, one or more values of one or more parameters of the machine-learned ranking model based on the asymmetric matching loss function.

11. The computing system of claim 10, wherein the pairwise scoring representation comprises a difference between the first predicted item score and the second predicted item score.

12. The computing system of claim 11, wherein the one or more label values comprise a first label value associated with the first item and a second label value associated with the second item, and wherein the pairwise label representation comprises a difference between the first label value and the second label value.

13. The computing system of claim 10, wherein the one or more label values and the pairwise label representation both comprise a preference label between the first item and the second item.

14. The computing system of claim 10, wherein the link function comprises a hyperbolic sine function or a hyperbolic sine function that has been one or both of scaled and shifted.

15. The computing system of claim 10, wherein the link function comprises a standard Sigmoid function or a Sigmoid function that has been one or both of scaled and shifted.

16. The computing system of claim 10, wherein the link function comprises an odd function asymmetric about an origin.

17. One or more non-transitory computer-readable media that collectively store computer-executable instructions for performing operations for listwise training, the operations comprising:
obtaining, by a computing system, a training example comprising: (i) data descriptive of a plurality of items and (ii) a plurality of label values respectively associated with the plurality of items;
processing, by the computing system, the data descriptive of the plurality of items with a machine-learned ranking model to generate a plurality of predicted item scores respectively for the plurality of items as an output of the machine-learned ranking model;
generating, by the computing system, a model-based discounted cumulative gain from the plurality of predicted item scores;
generating, by the computing system, a ground truth maximum discounted cumulative gain from the plurality of label values; and
evaluating, by the computing system, a matching loss function that matches the model-based discounted cumulative gain to the ground truth maximum discounted cumulative gain; and
modifying, by the computing system, one or more values of one or more parameters of the machine-learned ranking model based on the matching loss function.

18. The one or more non-transitory computer-readable media of claim 17, wherein a multiclass link function is defined with a generalization of a Softmax function in which a label generated score of each item is discounted by a discount which is a function of a position of the item in an ordering that maximizes an overall discounted cumulative gain score.

19. The one or more non-transitory computer-readable media of claim 17, wherein a link function for each item is linear, exponential, or other increasing function.

20. The one or more non-transitory computer-readable media of claim 17, wherein, in addition to matching a generalized Softmax score for each item of the plurality of items, an additional loss is applied to match a cumulative Softmax score of labels of all items with an asymmetric matching loss.

21. The one or more non-transitory computer-readable media of claim 17, wherein the matching loss function matches the plurality of predicted item scores to a gain-discount quotient determined using an applied gain and maximum gain based item ordering discount.
